(19) United States
(12) Patent Application Publication
(10) Pub. No.: US 2015/0197059 A1
(43) Pub. Date: Jul. 16, 2015

(54) IMPRINT APPARATUS AND IMPRINT METHOD

(71) Applicant: KABUSHIKI KAISHA TOSHIBA, Minato-ku (JP)

(72) Inventor: Satoshi USUI, Nagoya-shi (JP)

(73) Assignee: KABUSHIKI KAISHA TOSHIBA, Minato-ku (JP)

(21) Appl. No.: 14/200,561

(22) Filed: Mar. 7, 2014

Related U.S. Application Data
(60) Provisional application No. 61/925,973, filed on Jan. 10, 2014.

(51) Int. Cl. B29C 59/02

(52) U.S. Cl. CPC B29C 59/026; B29L 2007/001

(57) ABSTRACT

According to one embodiment, a guide plate is disposed around a periphery of the substrate holding unit, and is capable of moving in a direction orthogonal to a surface holding the substrate of the substrate holding unit. A controller is configured to control to cause the guide plate to move to a position where the template is not suffered from damage when the template is pressed to the substrate with a portion of the template extending outward from the substrate. A curing unit curies the imprint agent with the template being pressed to the substrate that the imprint agent is supplied thereon.

### CROSS-REFERENCE TO RELATED APPLICATIONS

This application is based upon and claims the benefit of priority from U.S. Provisional Application No. 61/925,973, filed on Jan. 10, 2014; the entire contents of which are incorporated herein by reference.

### FIELD

Embodiments described herein relate generally to an imprint apparatus and imprint method.

### BACKGROUND

Recently, it has been getting more important to achieve more downsizing and higher integration of semiconductor circuit. Conventionally, lithography technique has been the answer to those requirements. However, it leads too much high cost due to needs for complex optics and rare materials which are expensive generally. Accordingly, imprint lithography technique is getting focused as next high integration technique taking the place of the conventional lithography technique because there is no need for such complex optics and the expensive rare materials.

The imprint lithography is a technique generally including the steps of: coating an imprint agent above a wafer; imprinting a pattern to the imprint agent coated on the wafer with a template on which a desired pattern is physically formed in advance; and inversely transferring the desired pattern to the wafer. Resolution of the imprint lithography technique depends on only preciseness through a process of producing the template itself. For example, it may be possible, by using electron beam (EB) imaging device, to achieve a pattern whose resolution is greater than a resolution of the pattern obtained by using a conventional photo lithography technique.

Meanwhile, in the imprint lithography technique, when imprinting the pattern to an edge portion of the wafer, a part of the pattern extends outwardly across the edge of the wafer. The partial shot is only remained on the wafer, whereby the template is broken by contacting with the edge of the wafer, or the partial shot leads to undesired pattern formation on the wafer.

### BRIEF DESCRIPTION OF THE DRAWINGS

FIG. 1 is a schematic diagram of one example of a configuration of an imprint apparatus according to a first embodiment;

FIG. 2 is a plane view of a schematic diagram of one example of a configuration in vicinity of a stage of an imprint apparatus according to a first embodiment;

FIGS. 3A to 7B are schematic diagrams of one example of a process of an imprint method according to a first embodiment;

FIG. 8 is a schematic diagram of one example of a configuration of an imprint apparatus according to a second embodiment;

FIGS. 9A to 12B are schematic diagrams of one example of a process an imprint method according to the second embodiment;

FIG. 13 is a schematic cross-sectional views of one example of a processed pattern formed by an imprint method according to embodiments; and

FIG. 14 is a schematic diagram of another example of a configuration of an imprint apparatus according to the second embodiment.

### DETAILED DESCRIPTION

According to an embodiment, an imprint apparatus including a substrate holding unit, a template holding unit, an imprint agent supplying unit, a guide plate, a controller and a curing unit is provided. The substrate holding unit mounts a substrate thereon. The template holding unit is configured to hold a template with facing the substrate holding unit, and configured to press the template to the substrate. The imprint agent supplying unit supplies an imprint agent to an area to which the template is pressed. The guide plate is disposed around a periphery of the substrate holding unit, and is capable of moving in a direction orthogonal to a surface holding the substrate of the substrate holding unit. The controller is configured to control to cause the guide plate to move to a position where the template is not suffered from damage when the template is pressed to the substrate with a portion of the template extending outward from the substrate. The curing unit curies the imprint agent with the template being pressed to the substrate that the imprint agent is supplied thereon.

Exemplary embodiments of imprint apparatus and imprint method will be explained below in detail with reference to the accompanying drawings. The present invention is not limited to the following embodiments.

### First Embodiment

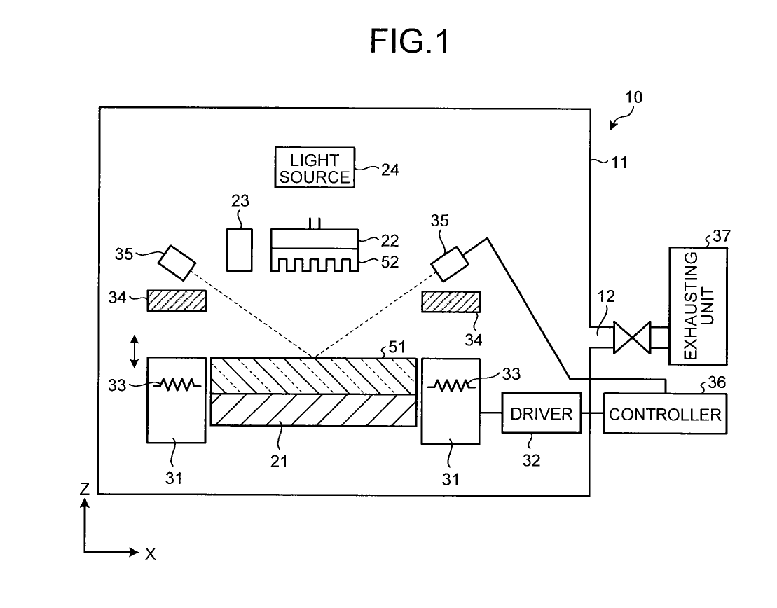

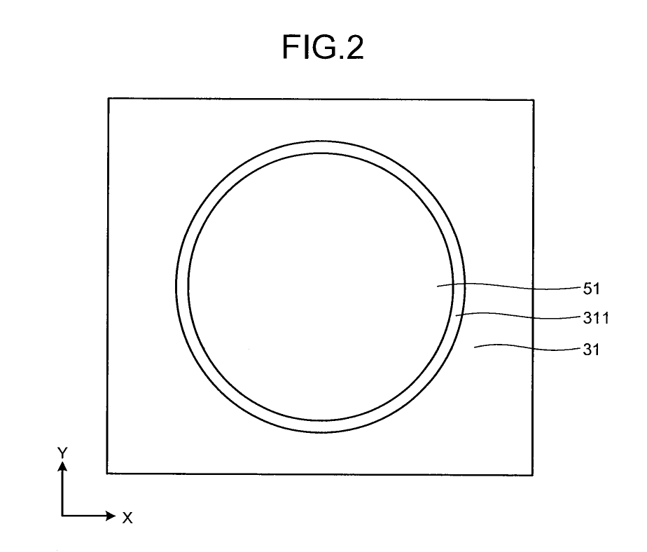

FIG. 1 is a schematic diagram of one example of a configuration of an imprint apparatus according to a first embodiment. FIG. 2 is a plane view of a schematic diagram of one example of a configuration in vicinity of a stage of an imprint apparatus according to a first embodiment. In these drawings, an X direction and a Y direction are defined as directions parallel to a surface of the substrate (e.g., wafer) and orthogonal to each other. A Z direction is defined as a direction orthogonal to both the X direction and the Y direction. In this embodiment, the Z-direction is a height direction, for example.

An imprint apparatus 10 is provided with a stage 21, a template holding mechanism 22, an imprint agent supplying unit 23 and a light source 24 within a chamber 11.

The stage 21 mounts a substrate 51 to be processed thereon with an electrostatic mechanism or a vacuum chuck mechanism, for example.

The template holding mechanism 22 holds the template 52 having a pattern which is transferred above the substrate 51 inversely with an electrostatic mechanism or a vacuum chuck mechanism, for example. More specifically, the template holding mechanism 22 holds the template 52 such that a plane on which the desired pattern is formed faces the stage 21. Additionally, the template holding mechanism 22 may be positioned above the stage 21 and freely moveable in the X direction, Y direction and Z direction with a moving mechanism (not shown).

The imprint agent supplying unit 23 drops an imprint agent onto the substrate 51. For example, the imprint agent supplying unit 23 is capable of supplying drops of the imprint agent onto the substrate 51 in a manner of ink jet. A solution liquid including a light curing resin may be used as the imprint agent, for example.

Subsequent to dropping the imprint agent onto the substrate 51, the light source 24 irradiates light to the imprint agent in a situation where the template 52 is pressed to the surface of the substrate 51. This makes the solution liquid including light curing resin cured. In a case where UV-curing resin is used as the imprint agent, UV light is emitted from the light source 24. The light source 24 functions as a resin curing unit.

The imprint apparatus 10 further includes a guide plate 31, a driver 32, a heater 33, a light protecting plate 34, a top surface level measuring unit 35, and a controller 36.

The guide plate 31 is located outside of a peripheral edge of the stage 21. A width of the guide plate 31 is defined such that a pattern portion imprinted with the template 52 other than the partial shot remaining on the wafer is accommodated within a top surface of the guide plate 31. For example, the guide plate 31 may be a metal plate made from solid materials.

In the example of FIG. 2 shown in a plane view, the substrate 51 (or stage 21) is formed in shape of a circle, and the guide plate 31 is formed in shape of a rectangular. The guide plate 31 has an aperture 311 at a center thereof, which has a diameter slightly greater than that of the substrate 51 (stage 21). The guide plate 31 is positioned such that the substrate 51 is capable of passing through the aperture 311.

The driver 32 drives the guide plate 31 in the Z direction such that the top surface of the guide plate 31 is common to that of the substrate 51.

The heater 33 heats the guide plate 31. It is preferable to use the heater 33 in order to quickly vapor the imprint agent remaining on the top surface of the guide plate 31 after curing the imprint agent above the substrate 51 and then removing the template 52 from the substrate 51. In other example, the heater 33 may be omitted.

The light protecting plate 34 blocks light emitted from the light source 24 to prevent the imprint agent dropped onto the top surface of the guide plate 31 from curing during a time period curing the imprint agent dropped onto the top surface of the substrate 51. The light protecting plate 34 is made from materials capable of blocking light having a desired wavelength, which is emitted from the light source 24. The light protecting plate 34 is positioned between the top surface of the guide plate 31 and the light source 24 in the Z direction.

The top surface level measuring unit 35 detects the position in the Z direction (i.e., vertical level) of the top surface of the substrate 51 mounted on the stage 21. For example, it is possible to obtain the position of the top surface of the substrate 51 by detecting the thickness of the substrate 51 using a laser displacement sensor for example, and adding the detected thickness to the position of the top surface of the stage 21.

The controller 36 controls the driver 32 so as to move the guide plate 31 in the Z direction based on the position of the top surface of the substrate 51 obtained with the top surface level measuring unit 35, such that the position of the top surface of the substrate 51 meets that of the guide plate 31, that is, both surfaces being coplanar. The controller 36 also controls processes such as supplying the imprint agent onto the top surfaces of the substrate 51 and the guide plate 31 by the imprint agent supplying unit 23, and pressing the template 52 onto the substrate 51 by the template holding mechanism 22.

The exhaust opening 12 is provided on the chamber 11. A conduit is connected to the exhaust opening 12. A exhausting unit 37 which exhausts gas within the chamber 11 is connected to the exhaust opening 12 via the conduit. It is preferable to provide the exhaust opening 12 in the vicinity of the top surface of the guide plate 31. The exhausting unit 37 allows the gas of the imprint agent which is vaporized, after pressing the template 52 onto the substrate 51 with the template holding mechanism 22, to be exhausted out of the chamber 11.

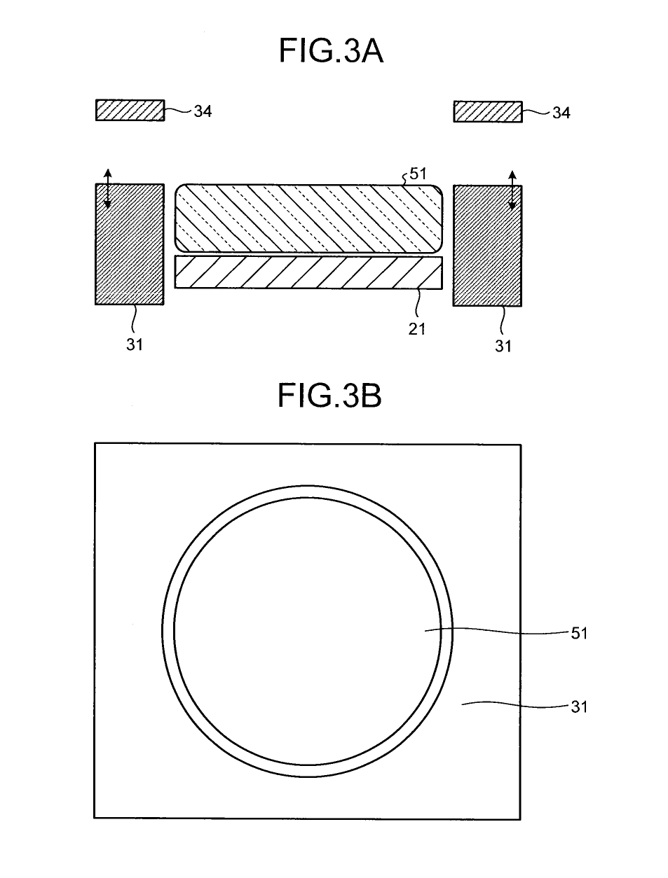

An imprint method performed in the imprint apparatus 10 including such a configuration is described as follows. FIGS. 3A to 7B are schematic diagrams of one example of a process of the imprint method according to a first embodiment. FIGS. 3A, 4A, 5A, 6A and 7A are cross-sectional view of area in the vicinity of the substrate 51, and FIGS. 3B, 4B, 5B, 6B and 7B are plane view of an area in the vicinity of the substrate 51. Specifically, the example of forming the pattern in a partial shot on the substrate 51 is described.

As shown in FIGS. 3A and 3B, first the substrate 51 is mounted on the stage 21. As described above, the guide plate 31 is located outside of a peripheral edge of the stage 21 in such a manner that a circumference of the stage 21 is surrounded with the guide plate 31. Then, the thickness of the substrate 51 is measured by the top surface level measuring unit 35. Signal representative of the measurement result is transmitted to the input of the controller 36. The controller 36 causes the driver 32 to move the position of the guide plate 31 in the Z direction based on the signal received such that the position of the top surface of the substrate 51 meets that of the guide plate 31, that is, both surfaces being coplanar. This results in no steps between the top surface of the substrate 51 and the top surface of the guide plate 31.

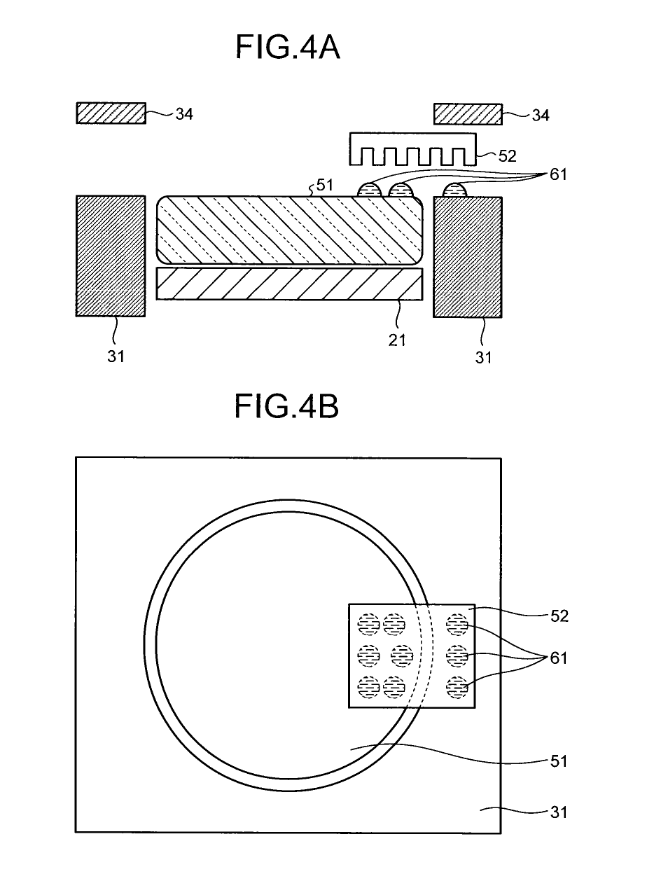

Subsequently, as shown in FIGS. 4A and 4B, the imprint agent 61 is dropped in a shot area with the imprint agent supplying unit 23. In this example, the imprint agent 61 is dropped onto both the top surface of the substrate 51 and the top surface of the guide plate 31 where the template 52 is to be pressed.

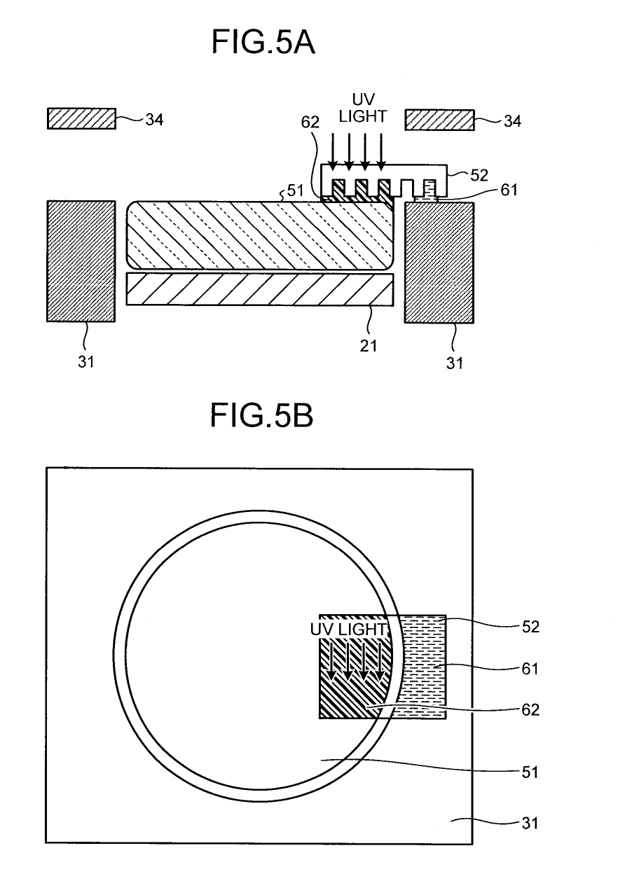

Then, as shown in FIGS. 5A and 5B, the template holding mechanism 22 causes the template 52 to move over the area where the imprint agent 61 is dropped and lower until contacting with the substrate 51. Then, the template 52 is pressed to the top surface of the substrate 51 at a predetermined pressure. At this time, a portion of the template holding mechanism 22 and the template 52 are positioned between the guide plate 31 and the light protecting plate 34. A light emitted from the light source 24 is irradiated in this condition. The light emitted from the light source 24 is transparent to both the template holding mechanism 22 and the template 52 on the substrate 51, so that the light reaches the imprint agent 61 put on the substrate 51. As a result, the imprint agent 61 changes in shape according to the pattern formed on the surface of the template 52 and cures so that a processed pattern 62 is inversely transferred from the template 52 to the substrate 51. On the other hand, the light emitted from the light source 24 is not transparent to both the template holding mechanism 22 and the template 52 on the guide plate 31 due to the light protecting plate 34, so that the light does not reach the imprint agent 61 put on the guide plate 31. As a result, the imprint agent 61 on the surface of the guide plate 31 remains in liquid without curing.

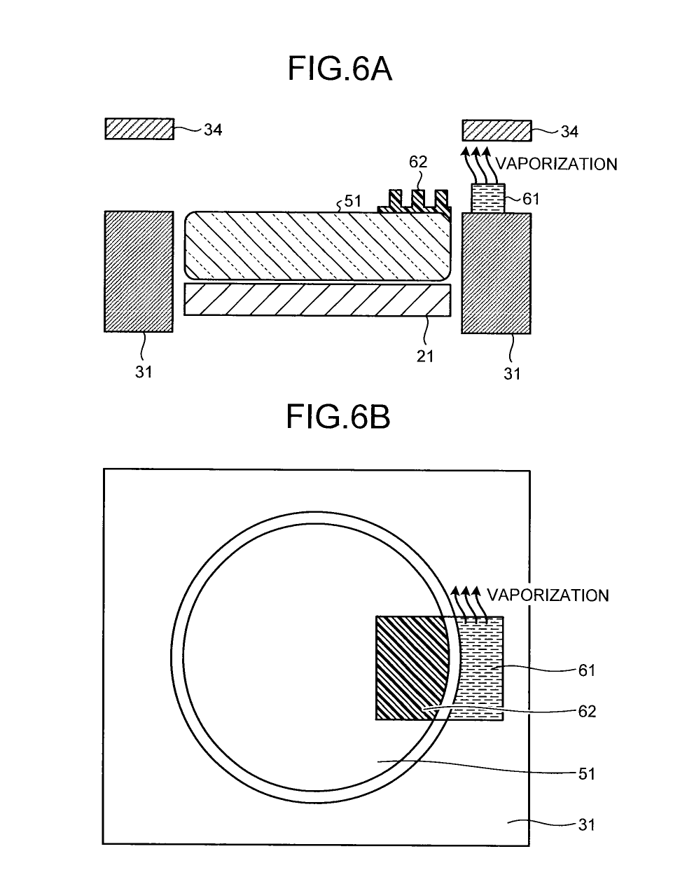

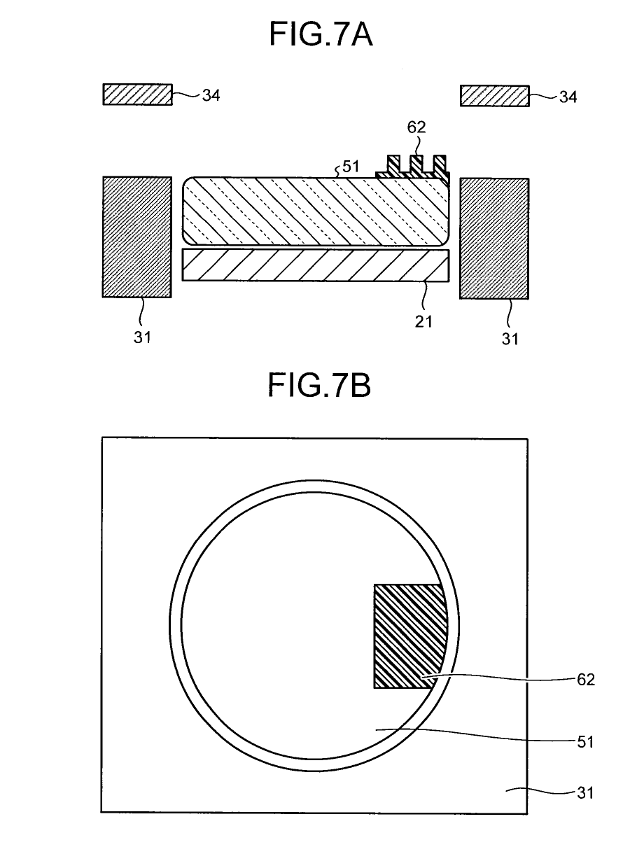

Subsequently, as shown in FIGS. 6A and 6B, the template 52 is moved away from the substrate 51. Thus, the processed pattern 62 remains above the substrate 51 and the imprint agent 61 remains on the guide plate 31 in liquid. In such a case where a line-and-space-shaped pattern is formed on the surface of the template 52, the processed pattern 62 is also formed with the line-and-space-shaped pattern. When heating the guide plate 31 by the heater 33, vaporization of the imprint agent 61 can be faster. As shown in FIGS. 7A and 7B, by vaporization, the imprint agent 61 is left in solid state only on the substrate 51. The imprint agent 61 on the guide plate 31 disappears. Thus, by using the processed pattern 62 as a mask for process, such as a dry etching process, the substrate 51 can be processed.

In the first embodiment, the guide plate 31 is located outside of a peripheral edge of the stage 21 such that the position of the top surface of the substrate 51 meets that of the guide plate 31, that is, both surfaces being coplanar. At imprinting, the imprint agent 61 is dropped on both the substrate 51 and the guide plate 31, and the imprint agent 61 is pressed with the template 52. The guide plate 31 at circumstance of the stage 21 prevents the template 52 from deforming at a bevel of the edge of the substrate 51 along a slope of the substrate 51, contacting with the substrate 51, and damaging thereby.

When irradiating the light while pressing the template 52 onto the substrate and the guide plate 31, the light protecting plate 34 is provided above the guide plate 31. Accordingly, the light does not reach the imprint agent 61 put on the guide plate 31, so that the imprint agent 61 put on the guide plate 31 does not cure. In addition, after the template 52 is removed, the imprint agent 61 put on the guide plate 31 is vaporized. Accordingly, it is possible to omit a cleaning process. That is, no cured imprint agent are left on the guide plate 31, whereby the cleaning step for cleaning the cured imprint agent is not necessary. By providing the heater 33 for heating the guide plate 31, vaporization of the imprint agent 61 in liquid can be faster. Therefore, it takes less time period for producing the processed pattern 62.

Furthermore, it is possible to prevent the vaporized imprint agent from depositing on the surface of the template 52 within the chamber 11 by using the exhausting unit 37 while vaporizing the imprint agent.

### Second Embodiment

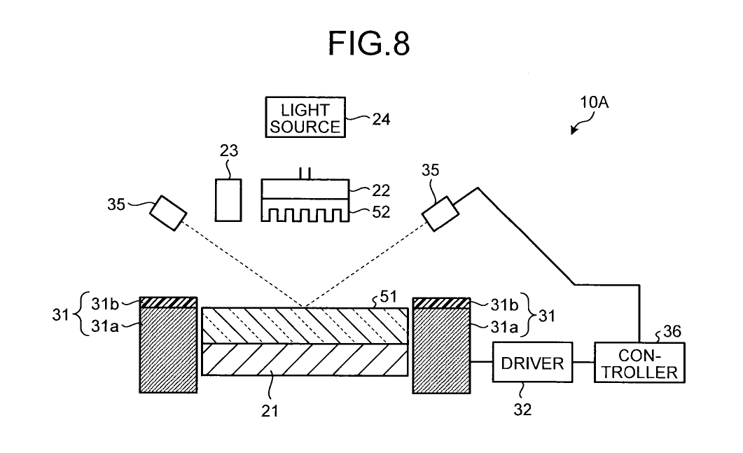

FIG. 8 is a schematic diagram of one example of a configuration of an imprint apparatus according to a second embodiment. The imprint apparatus 10A is similar to the imprint apparatus 10 illustrated in FIG. 1 except for a configuration in that the chamber 11, the exhausting unit 37, and the light protecting plate 34 are eliminated, and the guide plate 31 includes a main body portion 31a and a protecting member 31b.

The main body portion 31a is assembled by, for example, a metal plate made from solid materials. The protecting member 31b being disposed on the surface of the main body portion 31a is made from elastic materials such a gum. The main body portion 31a and the protecting member 31b are identical in shape in plane view.

The elements substantially identical in function and configuration as those of the first embodiment are denoted by like reference numerals, and description thereof are omitted.

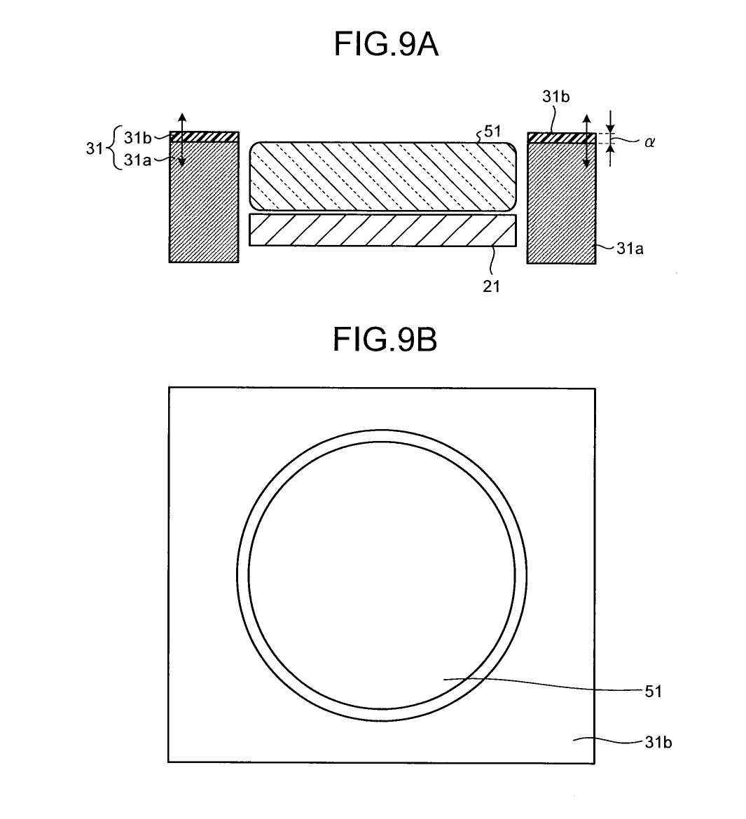

An imprint method performed in the imprint apparatus 10A including such a configuration is described as follows. FIGS. 9A to 12B are schematic diagrams of one example of a process of the imprint method according to a second embodiment. FIGS. 9A, 10A, 11A and 12A are cross-sectional views of an area in the vicinity of the substrate 51. FIGS. 9B, 10B, 11B and 12B are plane views of an area in the vicinity of the substrate 51. Specifically, the example of forming the pattern of a partial shot on the substrate 51 is described.

As shown in FIGS. 9A and 9B, first the substrate 51 is mounted on the stage 21. As described above, the guide plate 31 is located outside of a peripheral edge of the stage 21 in such a manner that a circumference of the stage 21 is surrounded with the guide plate 31. Then, the thickness of the substrate 51 is measured with the top surface level measuring unit 35. Signal representative of the measurement result is transmitted to the input of the controller 36. The controller 36 causes the driver 32 to move the guide plate 31 in the Z direction based on the signal received such that the position of the top surface of the protecting member 31b is higher than that of the substrate 51 by a predetermined height α.

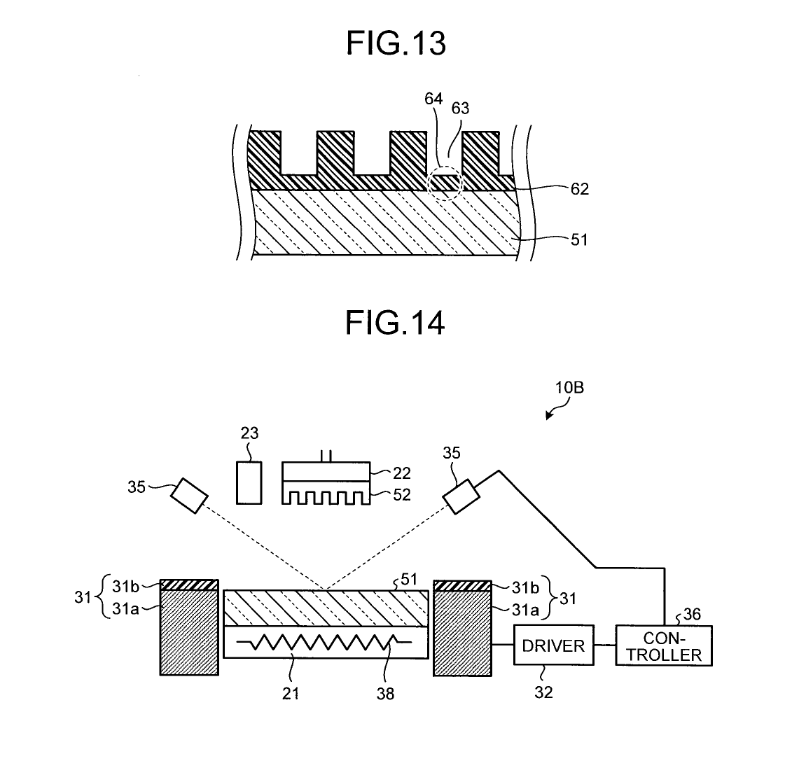

FIG. 13 is a schematic cross-sectional view of one example of a processed pattern formed by an imprint method. By the imprint method as described as the first embodiment, the processed pattern 62 is transferred to the surface of the substrate 51 with the pattern being reversed. The processed pattern 62 including a trench 63, and a bottom 64 of the trench 63 (a region which is corresponding to a convex portion of the template 52), which is not the surface of the substrate 51 but a residue made of the cured imprint agent having a predetermined thickness. The thickness of the bottom 64 is generally referred to as Residual Layer Thickness (hereinafter, referred to as RLT). For example, the RLT may be around 15 nm depending on a magnitude of pressure upon pressing the template 52 in imprint process.

The controller 36 controls the position of the guide plate 31 in the Z direction such that the predetermined height α is equal to the RLT. In the second embodiment, the imprint agent is not dropped onto the guide plate 31, so that, after curing the imprint agent 61, lower end positions (end position of the substrate 51 side) of the surface of the template 52 in the Z direction become equal both above the substrate 51 and above the guide plate 31.

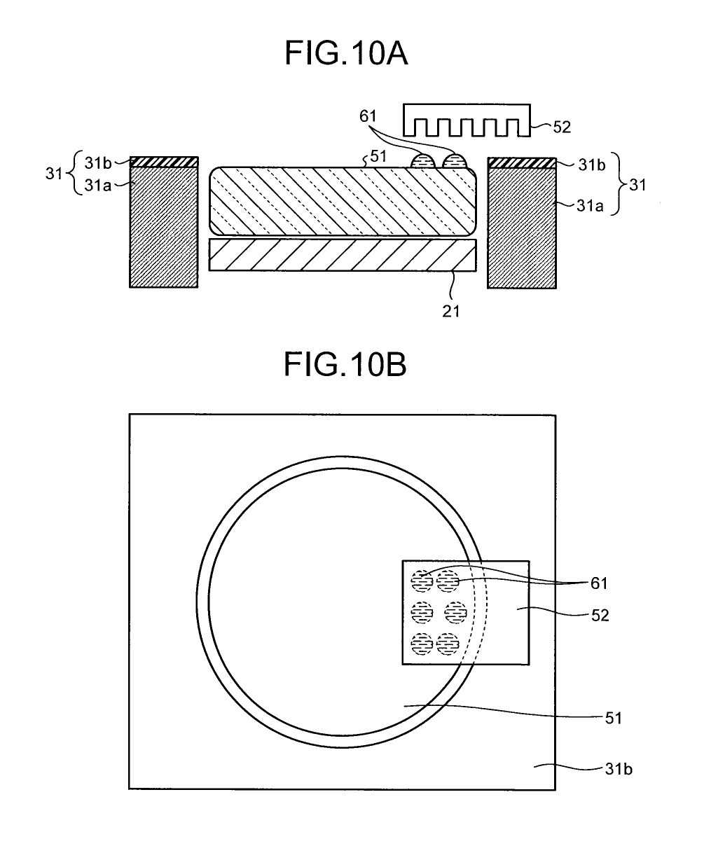

Then, as shown in FIGS. 10A and 10B, the imprint agent 61 is dropped onto the shot area of the substrate 51. Unlike the first embodiment, in the second embodiment, the imprint agent 61 is dropped only onto the top surface of the substrate 51 to which the template 52 is pressed. In other words, the imprint agent 61 is not dropped onto the top surface of the guide plate 31. The imprint agent 61 may contain a light curing resin.

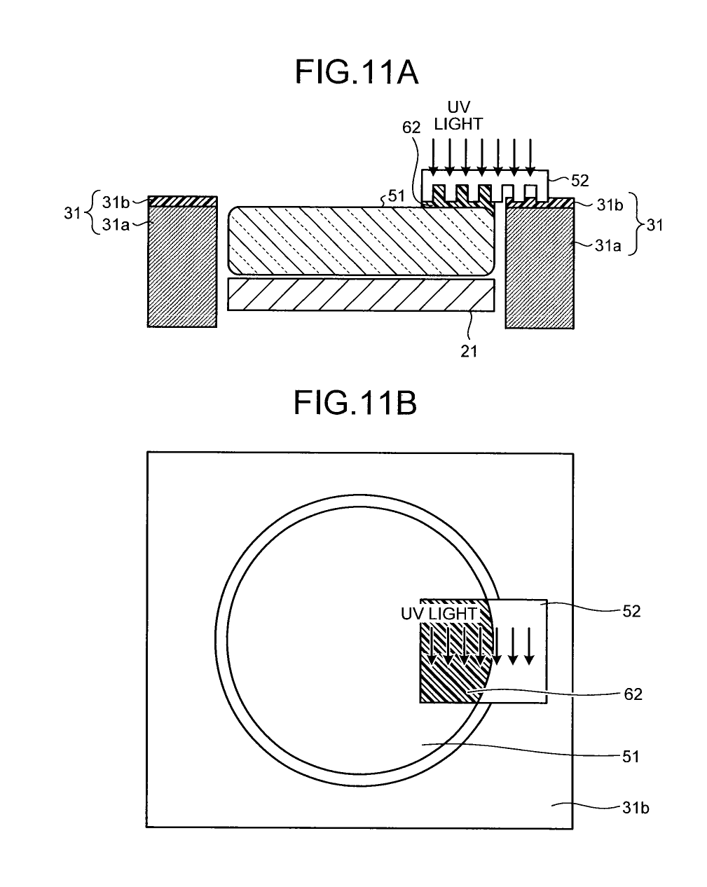

Subsequently, as shown in FIGS. 11A and 11B, the template holding mechanism 22 causes the template 52 to move over the area where the imprint agent 61 is dropped and lower until contacting with the substrate 51. Then, the template 52 is pressed both to the top surface of the substrate 51 and to that of the protecting member 31b at the predetermined pressure. A light emitted from the light source 24 is irradiated in this condition. The light emitted from the light source 24 is transparent both to the template holding mechanism 22 and to the template 52 on the substrate 51, so that the light reaches the imprint agent 61 put on the substrate 51. As a result, the imprint agent 61 changes in shape according to the pattern formed on the surface of the template 52 and cures so that a processed pattern 62 is inversely transferred from the template 52 to the substrate 51. Similarly, the light emitted from the light source 24 is transparent both to the template holding mechanism 22 and to the template 52 on the guide plate 31, so that the light reaches the top surface of the guide plate 31 (i.e., protecting member 31b). However, there is no imprint agent 61 on the guide plate 31, whereby curing of the imprint agent 61 does not occur on the guide plate 31.

The position of the top surface of the guide plate 31 in the Z direction is adjusted such that the position of the top surface of the protecting member 31b is higher than that of the substrate 51 by the RLT. As a result, the lower end positions of the surface of the template 52 in the Z direction become equal after curing the imprint agent 61 both above the substrate 51 and above the guide plate 31. When the position of the top surface of the guide plate 31 in the Z direction is not adjusted such that the position of the top surface of the protecting member 31b is higher than that of the substrate 51 by the RLT, the template 52 may be deformed or damaged due to stress occurred at a position of steps formed between the top surface of the substrate 51 and the top surface of the guide plate 31. The second embodiment can prevent such a situation.

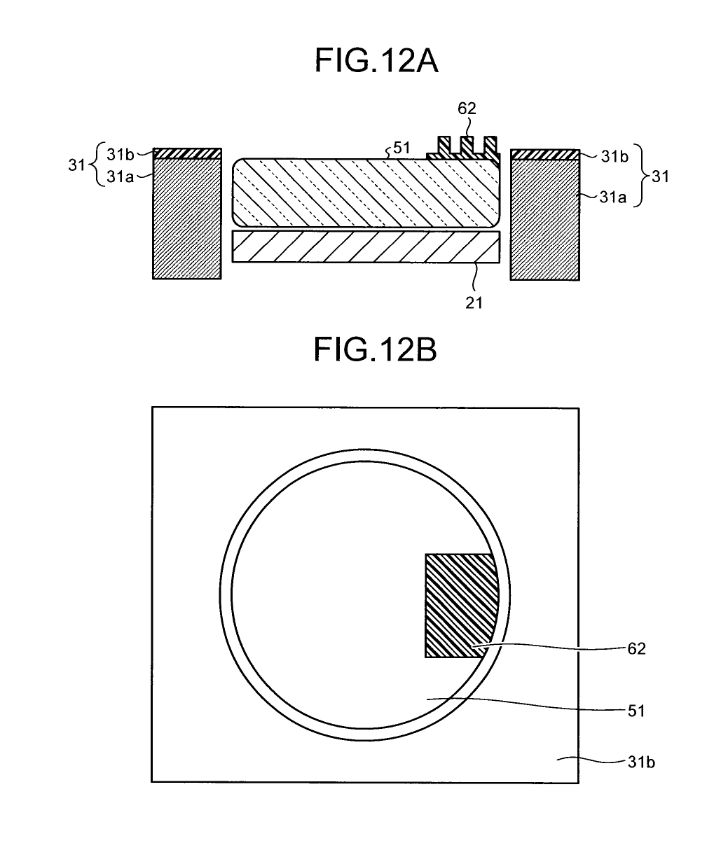

Subsequently, as shown in FIGS. 12A and 12B, the template 52 is moved away from the substrate 51. Thus, the processed pattern 62 remains only above the substrate 51. In such a case where a line-and-space-shaped pattern is formed on the surface of the template 52, the processed pattern 62 is also formed with the line-and-space-shaped pattern. In addition, the imprint agent 61 is not put on the top surface of the guide plate 31. Accordingly, the cleaning step for cleaning the top surface of the guide plate 31 is not necessary. Thus, by using the processed pattern 62 as a mask for process, such as a dry etching process, the substrate 51 can be processed to produce high dense semiconductor circuits.

In the above explanation, in the second embodiment, the case using the imprint agent 61 including light curing resin is exemplified. However, the imprint agent 61 containing thermal curing resins other than light curing resins may be used.

FIG. 14 is a schematic diagram of another example of a configuration of an imprint apparatus according to the second embodiment. The imprint apparatus 10B is similar to the imprint apparatus 10A illustrated in FIG. 8 except for a configuration in that the light source 24 is eliminated, and the stage 21 includes a substrate heater 38. The elements substantially identical in function and configuration as those of the first embodiment and FIG. 8 are denoted by like reference numerals, and description thereof are omitted.

In the imprint method using the imprint apparatus 10B including such a configuration as shown FIG. 14, as shown in FIGS. 10A and 10B, for example, the imprint agent 61 is dropped onto the shot area of the substrate 51. Then, the template 52 is pressed to the substrate 51 with a predetermined pressure, while the substrate heater 38 heats the substrate 51 during time period of curing the imprint agent 61. The imprint agent 61 may contain a thermal curing resin. Other process are similar to the above described process, therefore description thereof are omitted.

In the second embodiment, the protecting member 31b made from elastic materials is disposed on the surface of the main body portion 31a. The position of the top surface of the guide plate 31 in the Z direction is adjusted such that the position of the top surface of the protecting member 31b is higher than that of the substrate 51 by the RLT. The imprint agent 61 is dropped only onto the top surface of the substrate 51. Then, the template 52 is pressed both to the top surface of the substrate 51 and to that of the protecting member 31b at the predetermined pressure. This results in no steps between the top surface of the substrate 51 and the top surface of the guide plate 31. Consequently, deformation or damage of the template are effectively prevented. Less amount of the imprint agent 61 can be used because the imprint agent 61 is not dropped onto the guide plate 31. Furthermore, the number of times of the cleaning can be reduced because no imprint agent 61 is put on the guide plate 31.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An imprint apparatus comprising:
a substrate holding unit mounting a substrate thereon;
a template holding unit configured to hold a template with facing the substrate holding unit, and configured to press the template to the substrate;
an imprint agent supplying unit supplying an imprint agent to an area to which the template is pressed;
a guide plate disposed around a periphery of the substrate holding unit, the guide plate being capable of moving in a direction orthogonal to a surface holding the substrate of the substrate holding unit;
a controller configured to control to cause the guide plate to move to a position where the template is not suffered from damage when the template is pressed to the substrate with a portion of the template extending outward from the substrate; and
a curing unit curing the imprint agent with the template being pressed to the substrate that the imprint agent is supplied thereon.

2. The imprint apparatus according to claim 1 further comprising a top surface level measuring unit measuring a level of a top surface of the substrate mounted on the substrate holding unit, wherein
the imprint agent supplying unit supplies the imprint agent both to the top surface of the substrate being corresponding to the area to which the template is pressed and to the top surface of the guide plate, and
when the template is pressed to the top surface of the substrate with a portion of the template extending outward from the substrate, the controller causes the template to be pressed to the substrate after the controller causes the guide plate to move such that a top surface of the guide plate is common to the top surface of the substrate.

3. The imprint apparatus according to claim 2 further comprising a light protecting plate disposed between the guide plate and the curing unit corresponding to a disposed position of the guide plate, wherein
the imprint agent contains a light curing resin, and
the curing unit includes a light source emitting a light having wavelength capable of curing the light curing resin.

4. The imprint apparatus according to claim 3 further comprising a guide plate heating unit heating the guide plate.

5. The imprint apparatus according to claim 3 further comprising:
a chamber enclosing the substrate holding unit, the template holding unit, the imprint agent supplying unit, the guide plate, the curing unit, the top surface level measuring unit, and the light protecting plate; and
a exhausting unit exhausting gas within the chamber out thereof through an exhausting opening provided on the chamber.

6. The imprint apparatus according to claim 5, wherein the exhausting opening is provided on the chamber in the vicinity of the top surface of the guide plate.

7. The imprint apparatus according to claim 1 further comprising:
a top surface level measuring unit measuring a level of the top surface of the substrate mounted on the substrate holding unit, wherein
the imprint agent supplying unit supplies the imprint agent to the top surface of the substrate corresponding to the area to which the template is pressed, and
when the template is pressed to the substrate with a portion of the template extending outward from the substrate, the controller causes the template to be pressed to the substrate after the controller causes the guide plate to move such that the level of the top surface of the guide plate is higher than the level of the top surface of the substrate by a predetermined height.

8. The imprint apparatus according to claim 7, wherein the guide plate includes an protecting member made from elastic material on the top surface thereof.

9. The imprint apparatus according to claim 7, wherein the predetermined height is equal to a thickness of a cured portion obtained by imprinting, the cured portion corresponding to a convex portion of the pattern formed on the template.

10. The imprint apparatus according to claim 7, wherein
the imprint agent contains light curing resin, and
the curing unit includes a light source emitting a light having wavelength capable of curing the light curing resin.

11. The imprint apparatus according to claim 7, wherein
the imprint agent contains thermal curing resin, and
the curing unit includes a substrate heating unit provided in the substrate holding unit.

12. An imprint method comprising:
mounting a substrate on a substrate holding unit surrounded by an guide plate;
measuring a level of the top surface of the substrate;
causing the guide plate to move such that the top surface of the guide plate is common to the top surface of the substrate, when the template is pressed on the substrate with a portion of the template extending outward from the substrate;
supplying an imprint agent to an area to which the template is pressed including a top surface of the substrate and a top surface of the guide plate;
curing the imprint agent with the template being pressed to the substrate on which the imprint agent is supplied;
moving the template away from the substrate; and
vaporizing the imprint agent put on the guide plate.

13. The imprint method according to claim 12, wherein
the imprint agent contains a light curing resin, and
the curing the imprint agent includes irradiating a light having wavelength capable of curing the light curing resin.

14. The imprint method according to claim 13, wherein
the curing the imprint agent includes blocking the light reaching to the guide plate.

15. The imprint method according to claim 12, wherein
from the mounting a substrate to the vaporizing the imprint agent is performed within a chamber,
the vaporizing the imprint agent includes exhausting the vaporized imprint agent out of the chamber.

16. The imprint method according to claim 12, wherein
the vaporizing the imprint agent includes heating the guide plate.

17. An imprint method comprising:
mounting a substrate on a substrate holding unit surrounded by an guide plate;
measuring a level of the top surface of the substrate;
causing the guide plate to move such that the level of the top surface of the guide plate is higher than the level of the top surface of the substrate by a predetermined height, when the template is pressed to the top surface of the substrate with a portion of the template extending outward from the substrate;
supplying an imprint agent to an area to which the template is pressed including a top surface of the substrate;
curing the imprint agent with the template being pressed to the substrate on which the imprint agent is supplied; and
moving the template away from the substrate.

18. The imprint method according to claim 17, wherein the guide plate includes an protecting member made from elastic material on the top surface thereof.

19. The imprint method according to claim 17, wherein
the imprint agent contains a light curing resin, and
the curing the imprint agent includes irradiating a light having wavelength capable of curing the light curing resin.

20. The imprint method according to claim 17, wherein
the imprint agent contains thermal curing resin, and
the curing the imprint agent includes heating the substrate holding unit.
